(19) United States
(12) Patent Application Publication
(10) Pub. No.: US 2026/0349406 A1
(43) Pub. Date: Nov. 5, 2026

(54) NUMERICAL CONTROL DEVICE

(71) Applicant: FANUC CORPORATION, Yamanashi (JP)

(72) Inventor: Kazutaka IMANISHI, Yamanashi (JP)

(73) Assignee: FANUC CORPORATION, Yamanashi (JP)

(21) Appl. No.: 19/123,751

(22) PCT Filed: Nov. 7, 2022
(86) PCT No.: PCT/JP2022/041387

§ 371 Date: Apr. 23, 2025

(51) Int. Cl. G05B 19/409; G05B 19/406

(52) U.S. Cl. CPC G05B 19/409; G05B 19/406

(57) ABSTRACT

Provided is a numerical control device with which a user of a machine tool can easily confirm a payload. This numerical control device, which uses a numerical control program to control a robot via a robot control device, comprises: a payload confirmation state acquisition unit for acquiring from the robot control device a payload confirmation state indicating a state in which a payload setting and an actual payload are confirmed in the robot; and a payload-setting information confirmation unit for transmitting payload setting confirmation information for confirming the payload-setting information to the robot control device on the basis of the payload confirmation state, thereby completing the confirmation of the payload setting and the actual payload.

### TECHNICAL FIELD

The present disclosure relates to a numerical control device.

### BACKGROUND ART

Conventionally, technologies concerning collaborative robots that stop operating upon detecting contact with humans have been disclosed. For instance, in order to accurately measure the contact force of a collaborative robot, technologies for setting the payload information on a workpiece being held have been disclosed.

In order to automate machining sites, technologies concerning systems for operating robots from machine tools have been disclosed. For example, technologies for operating robots using numerical control commands familiar to machine tool users have been disclosed (see, for example, Patent Document 1).

### CITATION LIST

### Patent Document

Patent Document 1; Japanese Unexamined Patent Application, Publication No. 2014-241018

### DISCLOSURE OF THE INVENTION

### Problems to be Solved by the Invention

Collaborative robots need to execute payload confirmation upon each power-on to confirm whether the selected payload setting and the actual payload on the robot match. Machine tool users need to use unaccustomed teach pendants designed for robots in order to conduct payload confirmation; therefore, the operation to confirm the payload of collaborative robots is a challenging task for machine tool users. Therefore, there is a demand for a numerical control device that allows machine tool users to easily conduct payload confirmation.

### Means for Solving the Problems

An aspect of the present disclosure provides a numerical control device that controls a robot via a robot control device using a numerical control program, in which the numerical control device includes: a payload confirmation state acquisition unit that acquires a payload confirmation state, which serves as a state for confirming a payload setting and an actual payload in the robot, from the robot control device; and a payload-setting information confirmation unit that transmits payload-setting confirmation information for confirming payload-setting information to the robot control device, based on the payload confirmation state, and completes confirmation of the payload setting and the actual payload.

### BRIEF DESCRIPTION OF THE DRAWINGS

FIG. 1 is a functional block diagram of the numerical control system according to the present embodiment;

FIG. 2 is a functional block diagram of the numerical control device and the robot control device according to the present embodiment;

FIG. 3 is a diagram illustrating an example of payload-setting information;

FIG. 4 is a diagram illustrating the payload-setting information of Group 1 displayed when Group 1 is selected in FIG. 3;

FIG. 5 is a diagram illustrating an example of the payload-setting confirmation information displayed on a display device;

FIG. 6 is a sequence diagram illustrating the flow of signals and information between the numerical control device and the robot control device when displaying the payload-setting confirmation information illustrated in FIG. 5;

FIG. 7 is a diagram illustrating an example of the numerical control program according to the present embodiment; and

FIG. 8 is a sequence diagram illustrating the flow of signals and information between the numerical control device and the robot control device when executing the numerical control program illustrated in FIG. 7.

### PREFERRED MODE FOR CARRYING OUT THE INVENTION

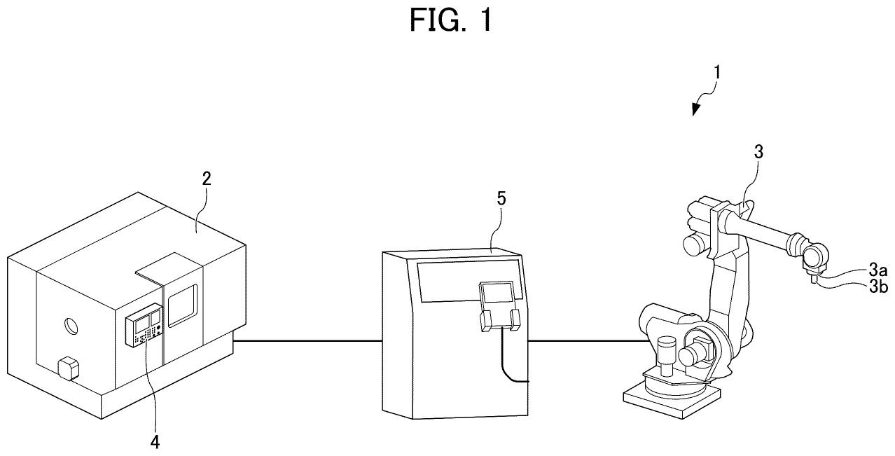

Hereinafter, an example of embodiments of the present disclosure will be described. FIG. 1 is a functional block diagram of a numerical control system 1 according to the present embodiment.

The numerical control system 1 includes a machine tool 2 that machines a workpiece (not illustrated), a numerical control device (CNC) 4 that controls the operation of the machine tool 2, a collaborative robot 3 installed near the machine tool 2, and a robot control device 5 that controls the operation of the collaborative robot 3. The numerical control system 1 utilizes the numerical control device 4 and the robot control device 5 communicatively connected to each other, thereby integrally controlling the operations of the machine tool 2 and the collaborative robot 3.

The machine tool 2 machines the workpiece (not illustrated) in accordance with machine tool control signals transmitted from the numerical control device 4. The machine tool 2 may include, for example, a lathe, drill press, milling machine, grinding machine, laser processing machine, or injection molding machine; however, this is not limiting.

The collaborative robot 3 operates under the control of the robot control device 5, and for example, executes predetermined tasks on the workpiece machined by the machine tool 2. The collaborative robot 3 is, for instance, a multi-joint robot with an arm, which includes a tip 3a attached with a tool 3b for gripping, machining, or inspecting the workpiece. In the following description, the collaborative robot 3 is described as a six-axis multi-joint robot; however, this is not limiting. In the following description, the collaborative robot 3 is described as a six-axis multi-joint robot; however, the number of axes is not limited thereto.

The collaborative robot 3 is provided with functions such as a contact stop function, a retreat mode function, and a reverse operation function, thus can safely work in collaboration with humans. The contact stop function immediately stops the robot upon contact with a human with a light force (e.g., 10 to 20 N or approximately 1 to 2 kgf). The retreat mode function allows the arm to retreat along each axis when a human pushes the arm of the collaborative robot 3. The reverse operation function immediately reverses the arm's motion when the collaborative robot 3 contacts a hard object, thereby reducing the pinching. The collaborative robot 3 includes external force detection sensors to detect external forces such as contact with a human. Examples of external force detection sensors include torque sensors and force sensors. Specifically, the collaborative robot 3 uses the external force detection sensors to detect contact with a human, and the robot control device 5 causes the collaborative robot 3 to stop operating in response to the external force detected by the external force detection sensors. As a result, the collaborative robot 3 can safely work in collaboration with humans.

The numerical control device 4 and the robot control device 5 are each a computer configured with hardware Components such as: an arithmetic processing unit such as a CPU (Central Processing Unit); an auxiliary storage unit such as HDD (Hard Disk Drive) or SSD (Solid State Drive) that stores various computer programs; a primary storage unit such as RAM (Random Access Memory) that stores data temporarily required for the arithmetic processing unit to execute computer programs; an operation unit such as a keyboard for an operator to execute various operations; and a display unit such as a display screen that presents various types of information to the operator. The numerical control device 4 and the robot control device 5 can communicate signals with each other, for example, via Ethernet (registered trademark).

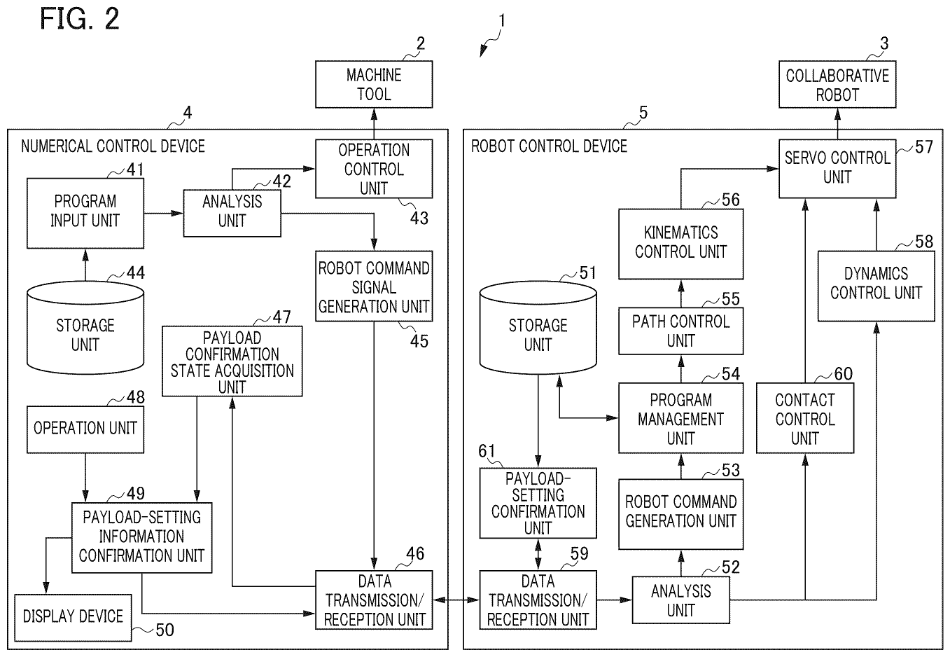

FIG. 2 is a functional block diagram of the numerical control device 4 and the robot control device 5 according to the present embodiment. First, the detailed configuration of the numerical control device 4 will be described. As illustrated in FIG. 2, the numerical control device 4 implements various functions through the above-described hardware configuration, such as the functions of controlling the operation of the machine tool 2 and generating motion paths of the control axes of the collaborative robot 3.

The numerical control device 4 controls the collaborative robot 3 via the robot control device 5 using a numerical control program. Specifically, the numerical control device 4 generates various commands for controlling the operations of the collaborative robot 3 and the tool 3b in accordance with a numerical control program for robots, and transmits the commands to the robot control device 5. More specifically, the numerical control device 4 includes a program input unit 41, an analysis unit 42, an operation control unit 43, a storage unit 44, a robot command signal generation unit 45, a data transmission/reception unit 46, a payload confirmation state acquisition unit 47, an operation unit 48, a payload-setting information confirmation unit 49, and a display device 50.

The program input unit 41 reads the numerical control program for robots, which consists of a plurality of robot command blocks, from the storage unit 44, and sequentially inputs the program into the analysis unit 42.

The analysis unit 42 analyzes the type of commands in the numerical control program input from the program input unit 41 for each command block, and outputs the analysis results to the operation control unit 43 and the robot command signal generation unit 45. More specifically, in a case where the type of command in the command block pertains to a machine tool numerical control command for the machine tool 2, the analysis unit 42 transmits the machine tool numerical control command to the operation control unit 43. In a case where the type of command in the command block pertains to a robotic numerical control command for the collaborative robot 3 (hereinafter also referred to as a “robot control command”), the analysis unit 42 outputs the robotic numerical control command to the robot command signal generation unit 45.

The operation control unit 43 generates machine tool control signals for controlling the operation of the machine tool 2, based on the analysis results transmitted from the analysis unit 42, and inputs the signals to the actuators that drive the various axes of the machine tool 2. The machine tool 2 operates based on the machine tool control signals input from the operation control unit 43, and machines the workpiece (not illustrated).

The storage unit 44 stores a plurality of numerical control programs created based on the operation by the operator. More specifically, the storage unit 44 stores numerical control programs consisting of a plurality of command blocks for controlling the operation of the machine tool 2, and a plurality of command blocks for controlling the operation of the collaborative robot 3. The numerical control programs stored in the storage unit 44 are described in known programming languages, such as G-code and M-code, for controlling the operation of the machine tool 2.

The storage unit 44 stores various machine coordinate values representing the positions of the axes of the machine tool 2 (e.g., the positions of the tool rest, table, etc. of the machine tool 2) operating under the numerical control program. The machine coordinate values are defined under a machine tool coordinate system, in which a reference point arbitrarily defined on or near the machine tool 2 serves as the origin. The storage unit 44 is sequentially updated through processing (not illustrated) so as to store the latest machine coordinate values, which continuously change under the numerical control program.

The storage unit 44 also stores robot coordinate values representing the position and posture of the control point of the collaborative robot 3 operating under the control of the robot control device 5 (e.g., the tip 3a of the arm of the collaborative robot 3), i.e., the positions of the control axes of the collaborative robot 3. The robot coordinate values are defined under a robot coordinate system that differs from the machine tool coordinate system described above. The storage unit 44 is sequentially updated through processing (not illustrated), based on the robot coordinate values obtained from the robot control device 5, so as to store the latest robot coordinate values, which continuously change under the numerical control program.

The storage unit 44 also stores teaching positions such as the starting points and ending points of the collaborative robot 3 input by the operator. Specifically, the storage unit 44 stores teaching positions of the collaborative robot 3 input via teach pendants or keyboards. The teaching positions of the collaborative robot 3 include robot coordinate values representing the positions of the control axes of the collaborative robot 3, in which the robot coordinate values are defined under the robot coordinate system that differs from the machine tool coordinate system.

The robot command signal generation unit 45 generates robot command signals for each robot command block, based on the analysis results of each robot command block input from the analysis unit 42, and writes the generated robot command signals in the data transmission/reception unit 46.

Specifically, the robot command signal generation unit 45 generates robot command signals for each robot command block, based on the robotic numerical control commands as the analysis results input from the analysis unit 42, and writes the generated robot command signals in the data transmission/reception unit 46.

The data transmission/reception unit 46 exchanges various types of data, such as commands and robot coordinate values, with the data transmission/reception unit 59 of the robot control device 5. Specifically, the data transmission/reception unit 46 transmits the robot command signals generated by the robot command signal generation unit 45 to the data transmission/reception unit 59 of the robot control device 5.

The operation unit 48 is configured with a teach pendant, a keyboard, or a touch panel, and receives input operations from the user. For example, the operation unit 48 receives the user's response to the payload-setting confirmation information in a question-based format described later.

The display device 50 is configured with a liquid crystal display, an organic electroluminescent display, or a touch panel display, and displays various information. For example, the display device 50 displays the payload-setting confirmation information described later.

The payload confirmation state acquisition unit 47 acquires the payload confirmation state from the robot control device 5. The payload confirmation state serves as the state for confirming the correspondence between the payload setting and the actual payload in the collaborative robot 3. The payload confirmation state includes any one of: unverified correspondence between the payload setting and the actual payload; no correspondence between the payload setting and the actual payload; or successfully verified correspondence between the payload setting and the actual payload.

Specifically, when a payload confirmation command is extracted from the analyzed robotic numerical control commands, the analysis unit 42 notifies the payload confirmation state acquisition unit 47 to acquire the payload confirmation state of the collaborative robot 3.

The payload confirmation state acquisition unit 47 outputs a command requesting the payload confirmation state to the robot command signal generation unit 45. The robot command signal generation unit 45 generates a robot command signal including the command requesting the payload confirmation state, and transmits the signal to the robot control device 5 via the data transmission/reception unit 46.

The robot control device 5 notifies the numerical control device 4 of the payload confirmation state in response to the robot command signal including the command for requesting the payload confirmation state. The payload confirmation state acquisition unit 47 acquires the payload confirmation state from the robot control device 5 via the data transmission/reception unit 59.

The payload-setting information confirmation unit 49 transmits the payload-setting confirmation information for confirming the payload-setting information to the robot control device 5, based on the payload confirmation state acquired by the payload confirmation state acquisition unit 47, and completes the confirmation of the correspondence between the payload setting and the actual payload in the collaborative robot 3.

Specifically, the payload-setting information confirmation unit 49 displays the payload-setting confirmation information in a question-based format on the display device 50, based on the payload confirmation state, and transmits the payload-setting confirmation information to the robot control device 5, based on the user's response to the payload-setting confirmation information in a question-based format.

The payload-setting information confirmation unit 49 transmits the payload-setting confirmation information to the data transmission/reception unit 59 of the robot control device 5, based on the payload confirmation state and the analysis results of the robotic numerical control command, completing the confirmation of the correspondence between the payload setting and the actual payload in the collaborative

In a case where the payload setting matches the actual payload in the collaborative robot 3, the payload-setting information confirmation unit 49 notifies the analysis unit 42 to permit the analysis of the next block of the robotic numerical control command. On the other hand, in a case where the payload setting and the actual payload do not match in the collaborative robot 3, the payload-setting information confirmation unit 49 notifies the analysis unit 42 to halt the analysis of the next block of the robotic numerical control command.

Upon receiving a notification to permit analysis of the next block of the robotic numerical control command, the analysis unit 42 analyzes the next block of the robotic numerical control command. On the other hand, in a case where the payload-setting information confirmation unit 49 determines that the payload-setting confirmation information and the payload setting do not match, the analysis unit 42 halts the analysis of the robotic numerical control command.

Next, the configuration of the robot control device 5 will be described in detail. As illustrated in FIG. 2, the robot control device 5 implements various functions through the hardware configuration, including a storage unit 51, an analysis unit 52, a robot command generation unit 53, a program management unit 54, a path control unit 55, a kinematics control unit 56, a servo control unit 57, a dynamics control unit 58, a data transmission/reception unit 59, a contact control unit 60, and a payload-setting confirmation unit 61. The robot control device 6 uses these functional units to control the operation of the collaborative robot 3, based on the commands transmitted from the numerical control device 4.

The storage unit 51 stores robot programs and various types of information for controlling the collaborative robot 3. The storage unit 51 also stores the payload-setting information of the collaborative robot 3. In the present embodiment, the storage unit 51 is provided within the robot control device 6; however, the storage unit 51 may also be provided within the numerical control device 4 or in external electronic equipment or servers separate from both the numerical control device 4 and the robot control device 6.

The payload-setting information may include payload setting numbers associated with the payload settings of the collaborative robot 3. The payload-setting information includes at least one of: the setting number of the payload, the weight of the payload, the position of the center of gravity of the payload, or the inertia of the payload. This payload-setting information is pre-input by an operator, and stored in the storage unit 51.

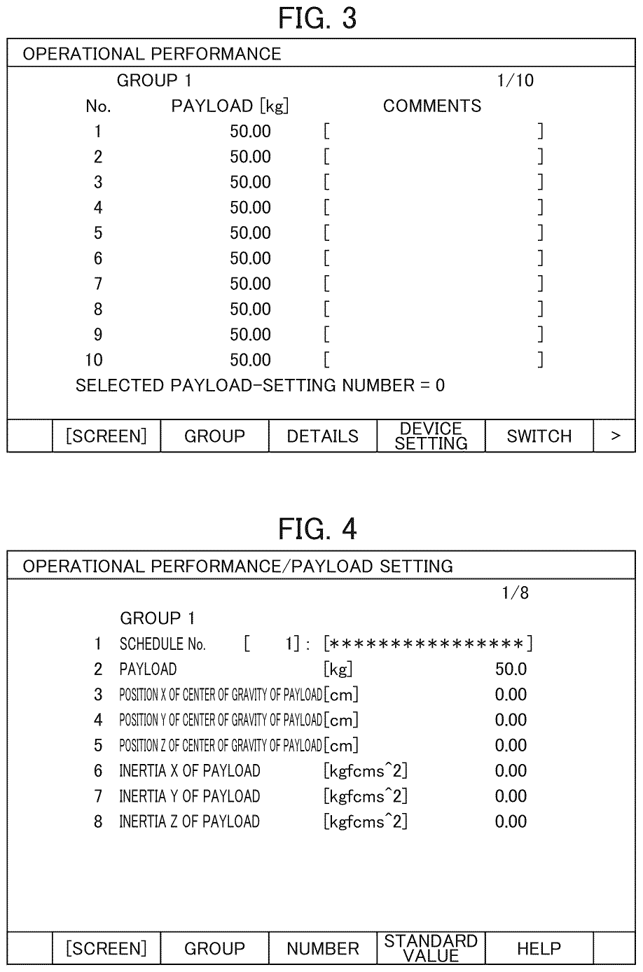

FIG. 3 is a diagram illustrating an example of payload-setting information. This payload-setting information is displayed on the screen of the display device 50 of the numerical control device 4. As illustrated in FIG. 3, for example, a group with a payload weight of 50 kg is assigned a plurality of setting numbers (Nos. 1 to 10).

FIG. 4 is a diagram illustrating the payload-setting information of Group 1 displayed when Group 1 in FIG. 3 is selected. The payload-setting information of Group 1 stores the weight of the payload, the position of the center of gravity of the payload, and the inertia value of the payload. In this manner, the storage unit 51 stores the weight, the position of the center of gravity, and the inertia in association with each payload.

Returning to FIG. 2, the data transmission/reception unit 59 receives robot command signals transmitted from the data transmission/reception unit 46 of the numerical control device 4. The data transmission/reception unit 59 sequentially outputs the received robot command signals to the analysis unit 52.

The analysis unit 52 analyzes the robot command signals input from the data transmission/reception unit 59. The analysis unit 52 outputs the analysis results to the robot command generation unit 53.

The robot command generation unit 53 generates robot commands corresponding to the robot command signals, based on the analysis results of the robot command signals input from the analysis unit 52. The robot command generation unit 53 outputs the generated robot commands to the program management unit 54.

When the robot commands are input from the robot command generation unit 53, the program management unit 54 sequentially executes the robot commands, thereby generating an operation plan for the collaborative robot 3 corresponding to the robot command signals, and outputting the plan to the path control unit 55.

In a case where the robot commands input from the robot command generation unit 53 are block robot commands, the program management unit 54 adds the input block robot commands to the robot program stored in the storage unit 51. As a result, a robot program corresponding to the robot command signal transmitted from the numerical control device 4 is generated and stored in the storage unit 51. The stored robot program is activated and executed when the program management unit 54 receives a robot program activation command as the robot command.

When an operation plan is input from the program management unit 54, the path control unit 55 calculates the time-series data of the control point of the collaborative robot 3, and outputs the data to the kinematics control unit 56.

The kinematics control unit 56 calculates the target angles of each joint of the collaborative robot 3, based on the input time-series data, and inputs the target angles to the servo control unit 57.

The servo control unit 57 executes feedback control of the servo motors of the collaborative robot 3 to achieve the target angles input from the kinematics control unit 56, thereby generating robot control signals for the collaborative robot 3, and inputting the robot control signals to the servo motors of the collaborative robot 3. The servo control unit 57 generates robot control signals incorporating the torque calculated by the dynamics control unit 58 described later. As a result, the robot control device 6 can control the collaborative robot 3, based on the payload-setting information.

The dynamics control unit 58 calculates the torques to be input into the collaborative robot 3 through inverse dynamics calculations, based on the payload settings commanded by the robot command signal. The dynamics control unit 58 outputs the calculated torques to the servo control unit 57.

Here, the inverse dynamics calculations of the collaborative robot 3 refer to a technique of calculating the input torque for each motor to implement desired motions (time-series data of positions, velocities, and accelerations of each joint) derived from the operational path plan of the collaborative robot 3. These calculations take into account external payloads applied to the hand, the gravitational forces, and the own weight of the collaborative robot 3.

Examples of inverse dynamics calculations include the computed torque method and the Newton-Euler method (as disclosed in, for example, Japanese Patent Application, Publication No. H8-118275 and Japanese Patent Application, Publication No. 2015-58520).

The contact control unit 60 controls the contact stop operation, based on the results of detecting external forces by the external force detection sensors of the collaborative robot 3. Here, the contact stop operation refers to the operation to stop the operation of the collaborative robot 3 in response to external contact forces.

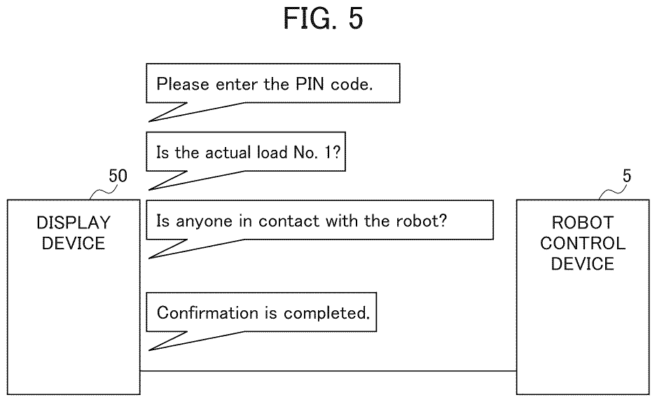

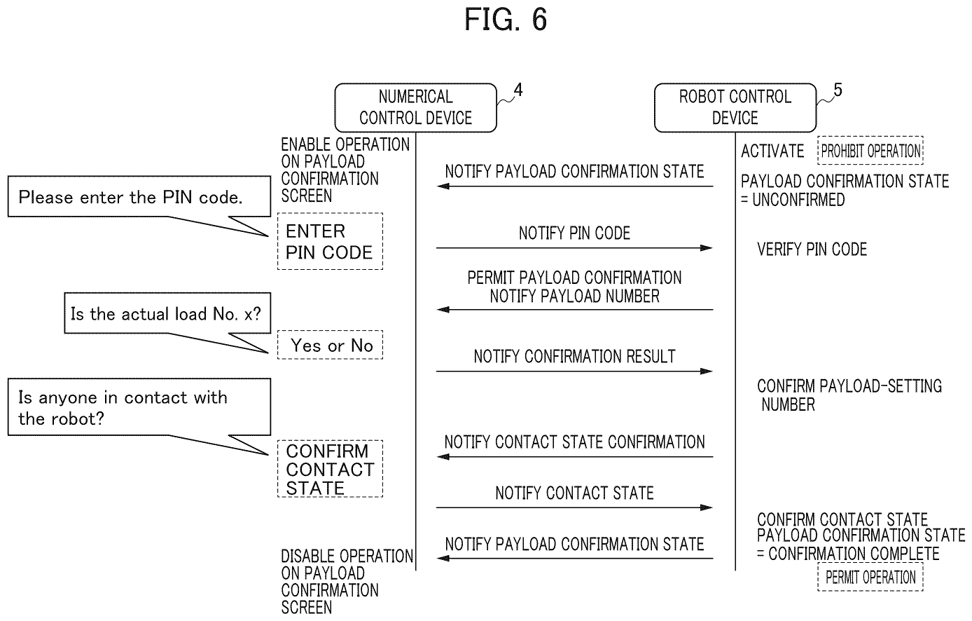

FIG. 5 is a diagram illustrating an example of the payload-setting confirmation information displayed on the display device 50. FIG. 6 is a sequence diagram illustrating the flow of signals and information between the numerical control device 4 and the robot control device 5 when displaying the payload-setting confirmation information illustrated in FIG. 5.

The payload-setting information confirmation unit 49 displays the payload-setting confirmation information in a question-based format on the display device 50, as follows, based on the payload confirmation state. First, the payload confirmation state acquisition unit 47 acquires the payload confirmation state notified from the robot control device 5.

In the examples illustrated in FIGS. 5 and 6, the payload confirmation state is “unconfirmed”. At this stage, the robot control device 5 prohibits the collaborative robot 3 from operating.

The payload-setting information confirmation unit 49 enables operations for the screen displaying the payload confirmation information on the display device 50, and displays the message “Please enter the PIN code” as the payload confirmation information on the display device 50.

Upon receiving the input of a PIN code from the user via the operation unit 48, the payload-setting information confirmation unit 49 notifies the robot control device 5 of the PIN code.

In a case where the notified PIN code matches the preset PIN code, the payload-setting confirmation unit 61 of the robot control device 5 permits payload confirmation, and notifies the numerical control device 4 of the payload setting number.

Next, the payload-setting information confirmation unit 49 displays the message “Is the actual payload No. x?” as the payload confirmation information on the display device 50. In this case, x represents an arbitrary payload-setting number.

When the operation unit 48 receives the selection operation of “YES” or “NO” from the user, the payload-setting information confirmation unit 49 notifies the robot control device 5 of the confirmation result indicating “YES” or “NO”.

The payload-setting confirmation unit 61 of the robot control device 5 verifies the payload setting number, based on the notified confirmation result, and notifies the numerical control device 4 of the information confirming the contact state with the collaborative robot 3.

Subsequently, the payload-setting information confirmation unit 49 displays the message “Is anyone in contact with the robot?” as the payload confirmation information on the display device 50. The user verifies that the collaborative robot 3 is not in contact with a human, and executes an operation to confirm the contact state via the operation unit 48. When the operation unit 48 receives an operation to confirm the contact state from the user, the payload-setting information confirmation unit 49 notifies the robot control device 5 of the contact state.

The payload-setting confirmation unit 61 of the robot control device 5 verifies the contact state, sets the payload confirmation state to “confirmation complete”, and notifies the numerical control device 4 of the payload confirmation state. The robot control device 5 permits the collaborative robot 3 to operate.

Upon receiving the payload confirmation state indicating that the confirmation is completed, the payload-setting information confirmation unit 49 displays the message “Payload confirmation is complete” on the display device 50, and disables operations on the screen displaying the payload confirmation information on the display device 50.

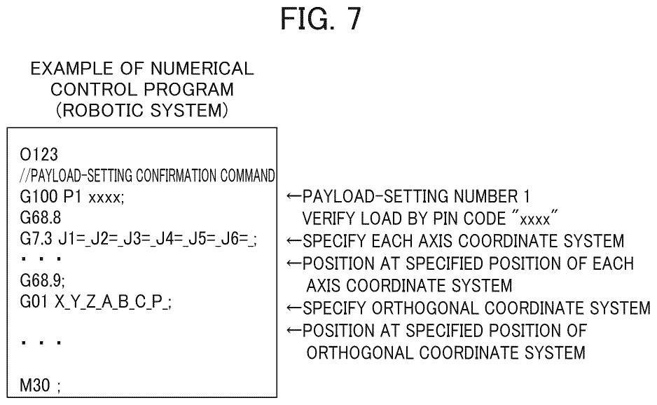

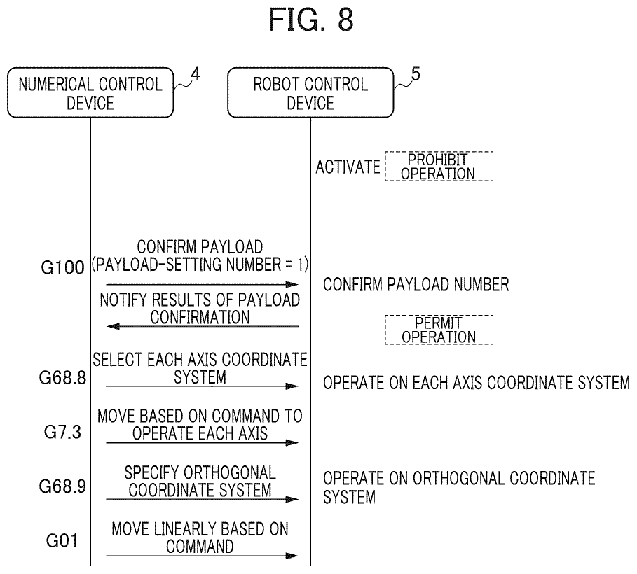

FIG. 7 is a diagram illustrating an example of the numerical control program according to the present embodiment. The numerical control program illustrated in FIG. 7 is a program for robotic systems. FIG. 8 is a sequence diagram illustrating the flow of signals and information between the numerical control device 4 and the robot control device 5 when executing the numerical control program illustrated in FIG. 7. In the examples illustrated in FIGS. 7 and 8, the payload confirmation state is “unverified”. At this stage, the robot control device 5 prohibits the collaborative robot 3 from operating.

In the numerical control program, “G100” is commanded first, and the payload confirmation state acquisition unit 47 acquires the payload confirmation state notified from the robot control device 5. The payload-setting information confirmation unit 49 displays a message as the payload confirmation information, based on the payload confirmation state, and receives the input of the PIN code “xxxx”. After the payload confirmation is permitted, the payload-setting information confirmation unit 49 notifies the numerical control device 4 of the payload setting number “No. 1”. Here, “xxxx” represents an arbitrary PIN code. Furthermore, when the operation unit 48 receives an operation to confirm the contact state from the user, the payload-setting information confirmation unit 49 notifies the robot control device 5 of the contact state.

The payload-setting confirmation unit 61 of the robot control device 5 verifies the PIN code, the payload setting number, and the contact state, and notifies the numerical control device 4 of the payload confirmation result. The robot control device 5 permits the collaborative robot 3 to operate.

Next, since the position of the collaborative robot 3 is unknown, “G68.8” is entered to select each axis coordinate system. When “G7.3 J1=_J2=_J3=_J4=_J5=_J6=_” is commanded, the robot control device 6 positions the collaborative robot 3 at the specified locations on the respective axis coordinate systems. The underscore portions of the command are replaced with the coordinate values of the specified locations for the collaborative robot 3.

Subsequently, “G68.9” is commanded to select an orthogonal coordinate system. When “G01 X_Y_Z_A_B_C_P_” is commanded, the robot control device 6 causes the collaborative robot 3 to linearly move to be positioned at the specified location (workpiece position) on the orthogonal coordinate system. The underscore portions in the command are replaced with the coordinate values of the specified location for the collaborative robot 3. In this manner, the numerical control device 4 can execute the numerical control program and confirm the payload-setting information.

As described above, according to the present embodiment, the numerical control device 4 includes: the payload confirmation state acquisition unit 47 that acquires the payload confirmation state, which serves as the state for confirming the payload setting and the actual payload in the collaborative robot 3, from the robot control device 5; and the payload-setting information confirmation unit 49 that transmits the payload-setting confirmation information for confirming the payload-setting information to the robot control device 5, based on the payload confirmation state, and completes the confirmation of the payload setting and the actual payload.

With this configuration, the numerical control device 4 can easily execute the payload confirmation of the collaborative robot 3 through operations on the numerical control device 4 familiar to the users of the machine tool 2, without the use of teach pendants of the robot control device 5.

The payload-setting information confirmation unit 49 displays the payload-setting confirmation information in a question-based format on the display device 50, transmits the payload-setting confirmation information to the robot control device 5, based on the user's response to the payload-setting confirmation information in a question-based format, and completes the confirmation of the payload setting and the actual payload. With this configuration, the numerical control device 4 can easily execute the payload confirmation of the collaborative robot 3 by allowing users of the machine tool 2 to respond to the payload-setting confirmation information in a question-based format.

The numerical control device 4 further includes the analysis unit 42 that analyzes the robotic numerical control commands within the numerical control program. The payload-setting information confirmation unit 49 transmits the payload-setting confirmation information to the robot control device 5, based on the analysis results of the payload confirmation state and the robotic numerical control commands, and completes the confirmation of the payload setting and the actual payload. With this configuration, the numerical control device 4 can execute payload confirmation of the collaborative robot 3, not only based on the payload confirmation state but also using the analysis results of the robotic numerical control commands.

In a case where the payload setting and the actual payload do not match, the analysis unit 42 halts the analysis of the robotic numerical control commands. With this configuration, the numerical control device 4 can halt the analysis of the robotic numerical control commands, thereby allowing for causing the collaborative robot 3 to stop operating when the collaborative robot 3 malfunctions.

The payload-setting information may include a number associated with the payload setting of the collaborative robot 3. The payload-setting information may also include at least one of: the weight of the payload; the position of the center of gravity of the payload; or the inertia information of the payload. With this configuration, the numerical control device 4 can appropriately confirm the payload setting of the While the embodiments of the present invention have been described above, the numerical control system 1 can be implemented using hardware, software, or a combination thereof. Similarly, the control methods executed by the numerical control system 1 can also be implemented using hardware, software, or a combination thereof. Implementation using software refers to execution by a computer that reads and executes a program.

The program can be stored in various types of non-transitory computer-readable media and supplied to a computer. Non-transitory computer-readable media include various types of tangible storage media. Examples of non-transitory computer-readable media include magnetic storage media (e.g., hard disk drives), magneto-optical storage media (e. g., magneto-optical disks), CD-ROM (Read Only Memory), CD-R, CD-R/W, and semiconductor memories (e. g., mask ROM, PROM (Programmable ROM), EPROM (Erasable PROM), flash ROM, and RAM (Random Access Memory)).

While the present disclosure has been described in detail, the present disclosure is not limited to the specific embodiments described above. These embodiments may be subject to various additions, replacements, modifications, and partial deletions, within a scope that does not deviate from the essence of the present disclosure or the scope of the claims and equivalents thereof. Additionally, these embodiments may be implemented in combination. For example, in the above-described embodiments, the order of operations or processing is merely exemplary and is not limited to the specific sequence. The same applies to numerical values or equations described in the embodiments.

The following additional remarks are disclosed concerning the above embodiments and modifications.

### Additional Remark 1

A numerical control device (4) that controls a robot (3) via a robot control device (5) using a numerical control program, the numerical control device (4) including:
a payload confirmation state acquisition unit (47) that acquires a payload confirmation state, which serves as the state for confirming the payload setting and the actual payload in the robot, from the robot control device; and
a payload-setting information confirmation unit (49) that transmits payload-setting confirmation information for confirming the payload-setting information to the robot control device, based on the payload confirmation state, and completes the confirmation of the payload setting and the actual payload.

### Additional Remark 2

The numerical control device as described in Additional Remark 1, in which the payload-setting information confirmation unit (49) displays the payload-setting confirmation information in a question-based format on a display device, transmits the payload-setting confirmation information to the robot control device, based on the user's response to the payload-setting confirmation information in a question-based format, and completes the confirmation of the payload setting and the actual payload.

### Additional Remark 3

The numerical control device as described in Additional Remark 1, further including an analysis unit (42) that analyzes robotic numerical control commands in the numerical control program, in which
the payload-setting information confirmation unit (49) transmits the payload-setting confirmation information to the robot control device, based on the analysis results of the payload confirmation state and the robotic numerical control commands, and completes the confirmation of the payload setting and the actual payload.

### Additional Remark 4

The numerical control device as described in Additional Remark 3, in which the analysis unit (42) halts the analysis of the robotic numerical control commands in a case where the payload setting and the actual payload do not match.

### Additional Remark 5

The numerical control device as described in Additional Remark 1 or 2, in which the payload-setting information includes a number associated with the payload setting of the robot.

The numerical control device as described in Additional Remark 1 or 2, in which the payload-setting information includes at least one of: weight of the payload; a position of a center of gravity of the payload; or inertia information of the payload.

### Additional Remark 7

The numerical control device as described in Additional Remark 1, in which the robot is a collaborative robot that stops operating upon detecting contact with a human.

### EXPLANATION OF REFERENCE NUMERALS

1: numerical control system
2: machine tool
3: collaborative robot
4: numerical control device
5: robot control device
41: program input unit
42: analysis unit
43: operation control unit
44: storage unit
45: robot command signal generation unit
46; operation unit data transmission/reception unit
47: payload confirmation state acquisition unit
48; operation unit
49: payload-setting information confirmation unit
50: display device
51: storage unit
52: analysis unit
53: robot command generation unit
54: program management unit
55: path control unit
56: kinematics control unit
57: servo control unit
58: dynamics control unit
59: data transmission/reception unit
60: contact control unit
61: payload-setting confirmation unit

1. A numerical control device that controls a robot via a robot control device using a numerical control program, the numerical control device comprising:
a payload confirmation state acquisition unit that acquires a payload confirmation state, which serves as a state for confirming a payload setting and an actual payload in the robot, from the robot control device; and
a payload-setting information confirmation unit that transmits payload-setting confirmation information for confirming payload-setting information to the robot control device, based on the payload confirmation state, and completes confirmation of the payload setting and the actual payload.

2. The numerical control device according to claim 1, wherein the payload-setting information confirmation unit displays the payload-setting confirmation information in a question-based format on a display device, transmits the payload-setting confirmation information to the robot control device, based on a user's response to the payload-setting confirmation information in a question-based format, and completes confirmation of the payload setting and the actual payload.

3. The numerical control device according to claim 1, further comprising an analysis unit that analyzes a robotic numerical control command in the numerical control program,
wherein the payload-setting information confirmation unit transmits the payload-setting confirmation information to the robot control device, based on an analysis result of the payload confirmation state and the robotic numerical control command, and completes confirmation of the payload setting and the actual payload.

4. The numerical control device according to claim 3, wherein the analysis unit halts an analysis of the robotic numerical control command in a case where the payload setting and the actual payload do not match.

5. The numerical control device according to claim 1, wherein the payload-setting information includes a number associated with the payload setting of the robot.

6. The numerical control device according to claim 1, wherein the payload-setting information includes at least one of: weight of the payload; a position of a center of gravity of the payload; or inertia information of the payload.

7. The numerical control device according to claim 1, wherein the robot is a collaborative robot that stops operating upon detecting contact with a human.
